(19) United States
(12) Patent Application Publication
(10) Pub. No.: US 2008/0080805 A1
(43) Pub. Date: Apr. 3, 2008

(54) Compensating method and compensator of first-order polarization mode dispersion, and optical transmission system using same

(75) Inventors: Hisao Nakashima, Kawasaki (JP); Takeshi Hoshida, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/882,062

(22) Filed: Jul. 30, 2007

(30) Foreign Application Priority Data
Sep. 29, 2006 (JP) 2006-268542

(51) Int. Cl. G02B 6/00

(52) U.S. Cl. 385/11

(57) ABSTRACT

In a PMD compensator of the present invention, a signal light input to an input terminal is supplied to a polarizer via a polarization controller; a part of polarized light transmitted through the polarizer is branched by an optical coupler as a monitor light; the monitor light is converted into a electrical signal by a photodiode; a clock corresponding to a RZ clock frequency of the signal light is extracted from the electrical signal using a band-pass filter, to thereby monitor the intensity thereof; and the polarization controller is feedback controlled by a PC control section so that the monitored intensity of the clock becomes maximum. As a result, a miniaturized and low-cost PMD compensator which can reliably compensate for first-order polarization mode dispersion of a RZ-pulsed signal light is provided.

### BACKGROUND OF THE INVENTION

1. Field of the Invention

The present invention relates to a technology for compensating for polarization mode dispersion (PMD) in the optical transmission, and in particular, to a compensating method and a compensator of first-order polarization mode dispersion for a RZ-pulsed signal light, and an optical transmission system using the same.

2. Description of the Related Art

In an optical transmission system having a transmission speed of 40 gigabit/second (Gbit/s) or higher, polarization mode dispersion (PMD) is a factor constraining a transmission distance. Therefore, there is demanded a technology for compensating for PMD or a modulation format having excellent PMD tolerance.

The PMD compensating technology is roughly divided into an optical level compensation mode and an electric level equalization mode. As the optical level compensation mode, there has been known a method of combining a high-speed polarization controller with a differential group delay (DGD) element canceling a first-order PMD in a transmission path, to monitor DGD based on a degree of polarization (DOP) of a received optical signal, thereby controlling the polarization controller or a method of combining a polarization controller and a polarizer to control the polarization controller based on the optical intensity of a signal light after transmitted through the polarizer (refer to Japanese Unexamined Patent Publication No. 11-196046, Japan National Phase Patent Publication No. 2005-502265 and the literature: “A comparison of different PMD-compensation techniques” by M. Karlsson et al., ECOC 2000, Vol. 2, pp 33-35). Such an optical level compensation mode has advantages of transmission rate-independence and modulation format-independence. However, since this optical level compensation mode needs a large number of parts, there are problems in miniaturization and cost reduction. On the other hand, in the electric level equalization mode, circuits such as a transversal filter and the like are incorporated into an optical reception IC circuit, to thereby perform the compensation of PMD. Such an electric level equalization mode has advantages of miniaturization and cost reduction, but has a problem of small compensation effect.

For the modulation format having the excellent PMD tolerance, in recent years, a RZ-DQPSK (Differential Quadrature Phase Shift Keying) format attracts attention. Since this RZ-DQPSK format is for transmitting related digital signals to 4 optical phases, a pulse repetition frequency is only a half (for example, 20 GHz) of a data transmission speed (for example, 40 Gbit/sec), and consequently, signal spectrum width is a half of that in a conventional NRZ (Non-Return-to-Zero) modulation format. Therefore, the RZ-DQPSK modulation format has excellent characteristics in DGD tolerance, chromatic dispersion tolerance, frequency utilization efficiency, device transmission performance and the like.

As a conventional technology relating to the PMD compensation on a signal light in RZ-pulsed modulation format, such as the above described RZ-DQPSK format, there has been proposed a technology for performing the PMD compensation on the RZ-DPSK (Differential Phase Shift Keying) format signal light in a configuration of combining a polarization controller and a polarization beam splitter (refer to the literature: “160 Gbit/s-based field transmission experiments with single-polarization RZ-DPSK signals and simple PMD compensator” by M. Daikoku et. al., ECOC'05, We2.2.1). In this conventional technology, as shown in FIG. 14, a polarization controller 101 and a polarization beam splitter 102 are arranged on an optical path on a former stage of a receiver, and polarization intensity of one of quadrature polarization components which are split by the polarization beam splitter 102 is detected by a photodiode 104 via an optical coupler 103 while polarization intensity of the other polarization component being detected by a photodiode 105, to thereby control the polarization controller 101 so that a difference between each polarization intensity becomes maximum. As a result, only the polarization component corresponding to one of principal states of polarization (PSP) of a transmission path shown by a Fast-axis and a Slow-axis in FIG. 14 is sent to the receiver as an output light, and a crosstalk component due to DGD in the received signal light is eliminated by the polarization beam splitter 102. Therefore, PMD generated in the transmission path can be compensated. Such an optical level PMD compensation mode using the polarization controller 101 and the polarization beam splitter 102 has a configuration without the necessity of using a DOP monitor, and therefore, the miniaturization and cost reduction of the PMD compensator can be expected.

However, in the conventional PMD compensation mode using the polarization controller 101 and the polarization beam splitter 102 as shown in FIG. 14, the polarization controller 101 is optimized utilizing the power difference between orthogonal polarized lights output from the polarization beam splitter 102. Therefore, there is a problem in that a control error in the polarization controller 101 becomes large in the case where the power difference between the orthogonal polarized lights corresponding to PSP is small.

To be specific, in the case where a power ratio between the orthogonal polarized lights corresponding to PSP, which are output from the polarization beam splitter 102, is 1:1, in the conventional control method of the polarization controller 101, as shown in FIG. 15 for example, the difference between the powers output from the polarization beam splitter 102 becomes small even in a state (the right side in FIG. 15) where PSP of the transmission path are deviated from an optimum point (the left side in FIG. 15) at which PSP of the transmission path are coincident with a principal plane direction of the polarization beam splitter 102, and consequently, the control for the polarization controller 101 is concluded. In such a state, since the respective components in directions of the Fast-axis and Slow-axis of the transmission path are mixed in the orthogonal polarized lights output from the polarization beam splitter 102, crosstalk due to DGD of the received signal light occurs. FIG. 16 shows one example of a relation of Q-value to a power rate between the orthogonal polarized lights corresponding to PSP, and if the power rate between the orthogonal polarized lights reaches the vicinity of 0.5, the PMD compensation performance is degraded so that Q-value in the receiver is abruptly lowered.

### SUMMARY OF THE INVENTION

The present invention has been accomplished in view of the above problems and has an object to realize a method of reliably compensating for first-order polarization mode dispersion of a signal light in RZ-pulsed modulation format, such as a RZ-DQPSK format or the like, and to provide a miniaturized and low-cost first-order polarization mode dispersion compensator and an optical transmission system using the same.

In order to achieve the above object, the present invention provides a compensating method of first-order polarization mode dispersion, for supplying a RZ-pulsed signal light, each symbol of which has a return-to-zero pulse shape in its intensity, to a polarization controller and a polarizer in sequence, to compensate for the first-order polarization mode dispersion of the signal light, comprising: photo-electrically converting a polarized light transmitted through the polarizer to generate a electrical signal; extracting, from the generated electrical signal, a clock having a frequency corresponding to a RZ clock frequency of the signal light; monitoring the intensity of the extracted clock; and controlling the polarization controller so that the monitored intensity of the clock becomes maximum.

A first-order polarization mode dispersion compensator according to the present invention, for supplying a RZ-pulsed signal light input to an input terminal thereof to a polarization controller and a polarizer in sequence, to output a signal light of which first-order polarization mode dispersion is compensated, via an output terminal thereof, comprises: an optical coupler which branches a part of a polarized light transmitted through the polarizer to be sent to the output terminal as a monitor light; a first photodiode which photo-electrically converts the monitor light branched by the optical coupler to generate a electrical signal; a first band-pass filter which extracts, from the electrical signal generated by the first photodiode, a clock having a frequency corresponding to a RZ clock frequency of the signal light; a first clock intensity monitor which monitors the intensity of the clock extracted by the first band-pass filter; and a control section that controls the polarization controller so that the intensity of the clock monitored by the first clock intensity monitor becomes maximum.

In the compensating method of the first-order polarization mode dispersion and the first-order polarization mode dispersion compensator as described in the above, the RZ-pulsed modulation format signal light is input to the polarizer via the polarization controller, the polarized light output from the polarizer is converted into the electric signal, the clock corresponding to the RZ clock frequency of the signal light is extracted from the electrical signal, and then, the intensity of the clock is monitored. Then, the polarization controller is controlled so that the monitored intensity of the clock becomes maximum, and thus, the first-order polarization mode dispersion can be compensated without depending on a power rate between orthogonal polarized lights of the signal light.

According to the compensating method of the first-order polarization mode dispersion, the first-order polarization mode dispersion of the RZ-pulsed modulation format signal light can be reliably compensated, and accordingly, it becomes possible to realize the miniaturized and low-cost first-order polarization mode dispersion compensator. Further, by constructing an optical transmission system by applying such a first-order polarization mode dispersion compensator, it becomes possible to realize excellent DGD tolerance in a receiver.

The other objects, features and advantages of the present invention will be apparent from the following description of the embodiments with reference to the accompanying drawings.

### BRIEF DESCRIPTION OF THE DRAWINGS

FIG. 1 is a diagram showing a configuration of a PMD compensator according to a first embodiment of the present invention;

FIG. 2 is a graph showing a waveform of a monitor light in the first embodiment;

FIG. 3 is a graph explaining a control method of a polarization controller in the first embodiment;

FIG. 4 is a graph showing a relation of Q-value to a rate of powers between orthogonal polarized lights in the first embodiment;

FIG. 5 is a diagram showing a configuration example of an optical transmission system to which the PMD compensator of the first embodiment is applied;

FIG. 6 is a graph showing one example of DGD tolerance in a receiver of the optical transmission system in FIG. 5;

FIG. 7 is a diagram showing a configuration of a PMD compensator according to a second embodiment of the present invention;

FIG. 8 is a diagram showing a configuration of a PMD compensator according to a third embodiment of the present invention;

FIG. 9 is a diagram showing another configuration example related to the third embodiment;

FIG. 10 is a diagram showing a configuration of a PMD compensator according to a fourth embodiment of the present invention;

FIG. 11 is a graph showing a waveform of the monitor light in the case where DGD in a RZ-pulsed phase modulation format signal light becomes a multiple of time slot of the signal light;

FIG. 12 is a graph showing an electric spectrum of a electrical signal in the case where DGD in the RZ-pulsed phase modulation format signal light becomes the multiple of time slot of the signal light;

FIG. 13 is a diagram showing another configuration example related to the fourth embodiment;

FIG. 14 is a diagram showing a configuration of a conventional PMD compensator;

FIG. 15 is a diagram explaining problems in the conventional PMD compensator; and

FIG. 16 is a graph showing a relation of Q-value to a rate of powers between orthogonal polarized lights in the conventional PMD compensator.

### DETAILED DESCRIPTION OF THE INVENTION

Hereinafter, embodiments of the present invention will be described with reference to drawings. The same reference numerals denote the same or equivalent parts in all drawings.

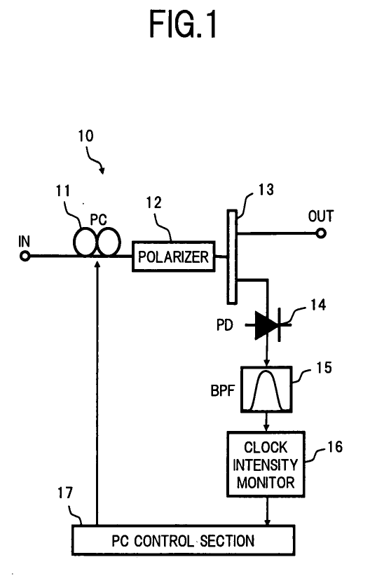

FIG. 1 is a diagram showing a configuration of a PMD compensator according to a first embodiment of the present invention.

In FIG. 1, a PMD compensator 10 of the present embodiment comprises for example: a polarization controller (PC) 11 connected to an input terminal IN; a polarizer 12 to which an output light from the polarization controller 11 is input; an optical coupler 13 which branches a transmitted light from the polarizer 12 into two; a photodiode (PD) 14 connected to one of output ports of the optical coupler 13; a band-pass filter (BPF) 15 to which an output signal from the photodiode 14 is input; a clock intensity monitor 16 to which a transmission signal from the band-pass filter 15 is input; and a PC control section 17 that controls the polarization controller 11 according to an output signal from the clock intensity monitor 16.

The polarization controller 11 receives a signal light having been propagated through a transmission path (not shown in the figure) or the like, which is connected to the input terminal IN, to control a polarization state of the signal light in accordance with a control signal from the PC control section 17. The signal light supplied to the input terminal IN is a signal light in RZ-pulsed modulation format (for example, a RZ format, a RZ-DQPSK format, a CS(Carrier Suppressed)RZ-DQPSK format, RZ-DPSK format, CSRZ-DPSK format or the like). The polarizer 12 is a well-known optical device which transmits therethrough an optical component of main polarizing axis while blocking other optical components.

The optical coupler 13 branches the polarized light transmitted through the polarizer 12 into two in accordance with a required branching ratio, and outputs one of the branched lights to an output port OUT while outputting the other branched light to the photodiode 14 as a monitor light. The photodiode 14 photo-electrically converts the monitor light branched by the optical coupler 13 to generate a electrical signal, and outputs the electrical signal to the band-pass filter 15.

The band-pass filter 15 which has a transmission band of which center frequency is set corresponding to a RZ clock frequency of the signal light input to the input terminal IN, extracts a RZ clock from the electrical signal output from the photodiode 14, to output the RZ clock to the clock intensity monitor 16. The RZ clock frequency of the signal light is, for example, 20 GHz in the case of the RZ-DQPSK signal of 40 Gbit/sec and 40 GHz in the case of the RZ-DPSK signal light of 40 Gbit/sec, and further, 20 GHz in the case of the CSRZ-DQPSK signal light of 40 Gbit/sec and 40 GHz in the case of the CSRZ-DPSK signal light of 40 Gbit/sec.

The clock frequency monitor 16 monitors the intensity of the clock extracted by the band-pass filter 15, to output a monitor result thereof to the PC control section 17. The PC control section generates a signal for controlling an operation state of the polarization controller 11 to output the generated control signal to the polarization controller 11, so that the intensity of the clock monitored by the clock intensity monitor 16 becomes maximum.

Next, there will be described an operation of the first embodiment.

In the PMD compensator 10 of the above configuration, the signal light which has been propagated through the transmission path to be input to the input terminal IN passes through the polarization controller 11 to be supplied to the polarizer 12, and the polarization component in the same direction as the main polarizing axis of the polarizer 12 is transmitted through the polarizer 12 while other polarization components being blocked. The transmitted light from the polarizer 12 is branched into two in the optical coupler 13, and one of the branched lights is sent via the output terminal OUT to a receiver (not shown in the figure) or the like, while the other branched light being supplied to the photodiode 14 as the monitor light. The monitor light input to the photodiode 14 is converted into the electrical signal, and thereafter, the clock thereof is extracted by the band-pass filter 15, so that the intensity of the clock is monitored by the clock intensity monitor 16.

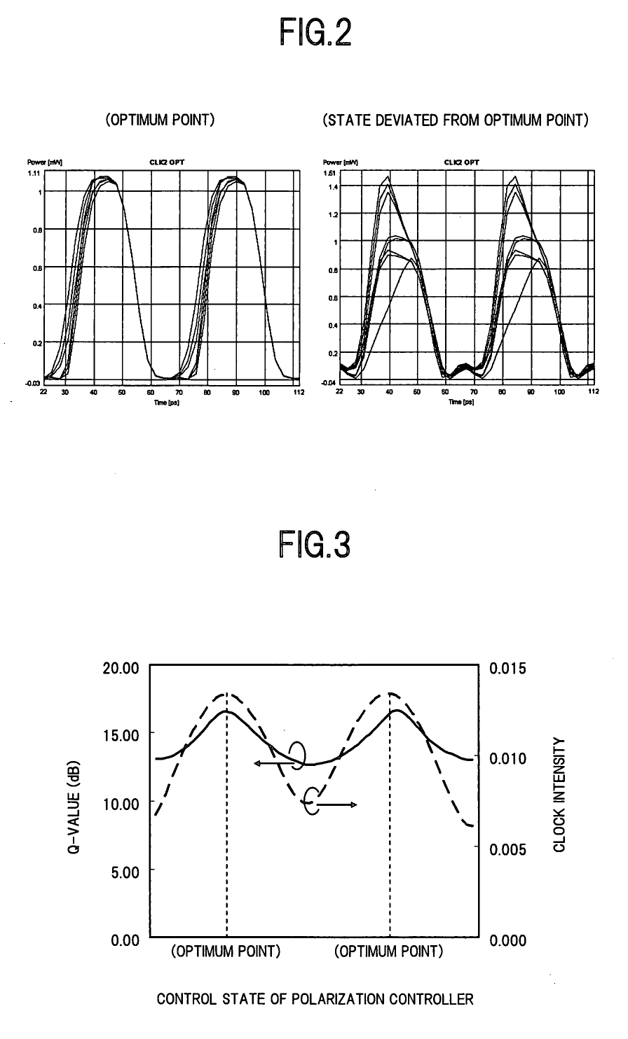

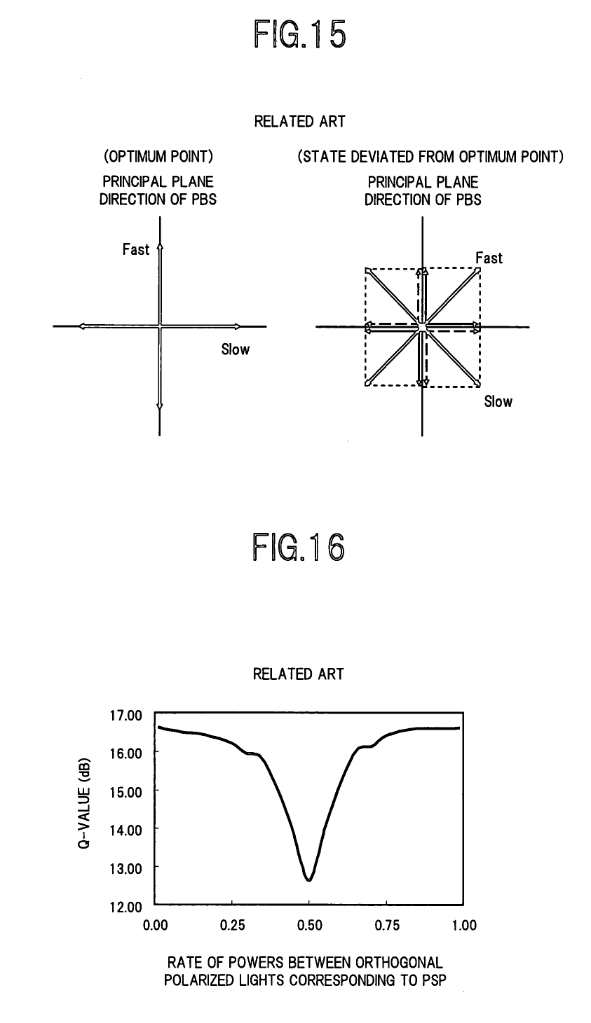

At this time, in the case where the polarization controller 11 is controlled at an optimum point (refer to the left side of FIG. 15), since a crosstalk component due to DGD is eliminated by the polarizer 12, the monitor light input to the photodiode 14 has a clear clock waveform corresponding to the RZ pulse of the signal light as shown in the left side of FIG. 2 for example, so that the intensity of the clock monitored by the clock intensity monitor 16 becomes maximum. On the other hand, in the case where the polarization controller 11 is controlled in a deviated state from the optimum point (refer to the right side of FIG. 15), since two orthogonal signal light components of different delay amounts interferes with each other due to DGD in the transmission path, the monitor light input to the photodiode 14 has a distorted clock waveform as shown in the right side of FIG. 2, so that the intensity of the clock monitored by the clock intensity monitor 16 is lowered.

Paying attention to a change in the clock intensity as described in the above, in the present PMD compensator 10, the polarization controller 11 is feedback controlled by the PC control section 17 so that the clock intensity monitored by the clock intensity monitor 16 becomes maximum as shown by a broken line in FIG. 3. Q-value in the receiver of the signal light which is PMD compensated by applying the above feedback control reaches the best value in the vicinity of the maximum point of the clock intensity as shown by a solid line in FIG. 3.

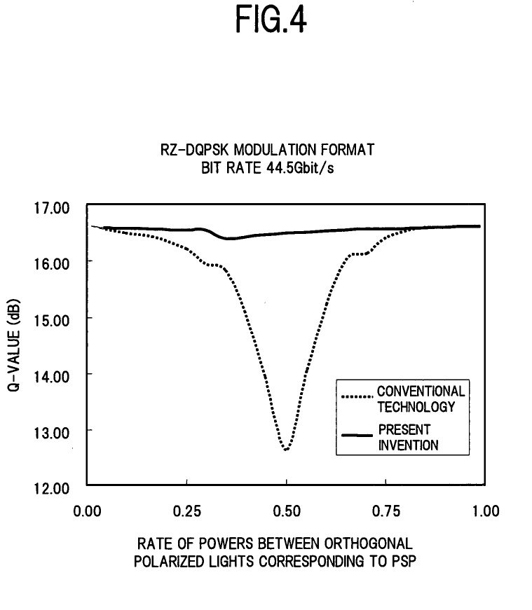

FIG. 4 shows one example in which, corresponding to a relation of Q-value to a rate of powers between orthogonal polarized lights corresponding to PSP in a conventional technology shown in FIG. 16, a similar relation in the PMD compensator of the present invention is obtained. Herein, a RZ-DQPSK signal light of 44.5 Gbit/sec is supposed. From FIG. 4, it is understood that, by applying the PMD compensation mode according to the present invention, power dependence between the orthogonal polarized lights, which has been the problem in the conventional technology, is significantly improved.

According to the first embodiment as described above, it becomes possible to realize the miniaturized and low-cost PMD compensator which can reliably compensate for the first-order polarization mode dispersion of the signal light in RZ-pulsed modulation format signal light, such as the RZ-DQPSK format or the like.

Next, there will be described an optical transmission system to which the PMD compensator according to the present invention is applied.

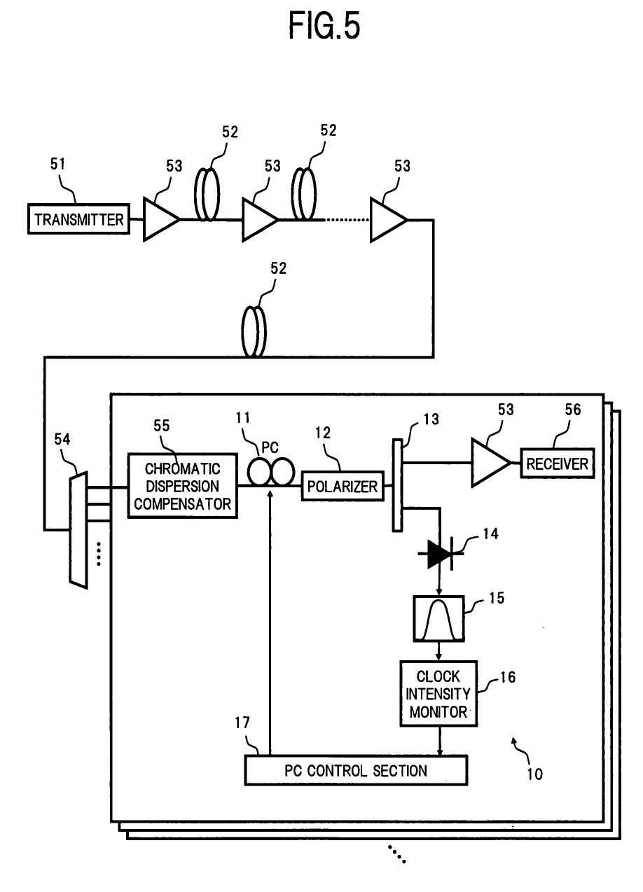

FIG. 5 is a diagram showing a configuration example of the optical transmission system to which the PMD compensator of the first embodiment is applied.

In the configuration example of the optical transmission system shown in FIG. 5, a WDM light in which a plurality of RZ-pulsed modulation format signal lights of different wavelengths are multiplexed, is transmitted from a transmitter 51 to a transmission path 52 to be repeatedly transmitted to a reception end, while a loss thereof in the transmission path 52 being compensated by optical amplifiers 53 arranged on the transmission path 52 at required intervals. At the reception end, the repeatedly transmitted WDM light is demultiplexed into signal lights of respective wavelengths by a demultiplexer 54. Each of the signal lights is supplied to a corresponding chromatic dispersion compensator 55 in which the chromatic dispersion in the transmission path 52 is compensated, and thereafter, is input to the PMD compensator 10 of the first embodiment. In the PMD compensator 10, as described in the above, a part of the signal light passed through the polarization controller 11 and the polarizer 12 is branched by the optical coupler 13 as the monitor light, and the polarization controller 11 is feedback controlled using the monitor light, so that the signal light which has been PMD compensated at the optimum point is output.

Incidentally, since the feedback control of the polarization controller 11 is performed by monitoring the intensity of the clock corresponding to the RZ clock frequency of the signal light as described in the above, if the signal light having the distorted waveform due to the chromatic dispersion in the transmission path is input to the PMD compensator 10, the control of PC 11 is unstable because the distortion of RZ pulse is caused by the chromatic dispersion. Therefore, it is required to perform the chromatic dispersion compensation at a former stage of the PMD compensator 10.

Further, in the case where a power ratio between orthogonal polarized lights of the signal light input to the PMD compensator 10 or a principal state of polarization (PSP) of the transmission path is changed, the power of the signal light output from the PMD compensator 10 is varied. Therefore, depending on a dynamic range of the receiver, it is required to arrange the optical amplifier 53 on a latter stage of the PMD compensator 10 to thereby perform an automatic level control on the PMD compensator 10.

The signal light amplified to a required level by the optical amplifier 53 on the latter stage of the PMD compensator 10 is sent to a well-known receiver 56 to be subjected to reception processing.

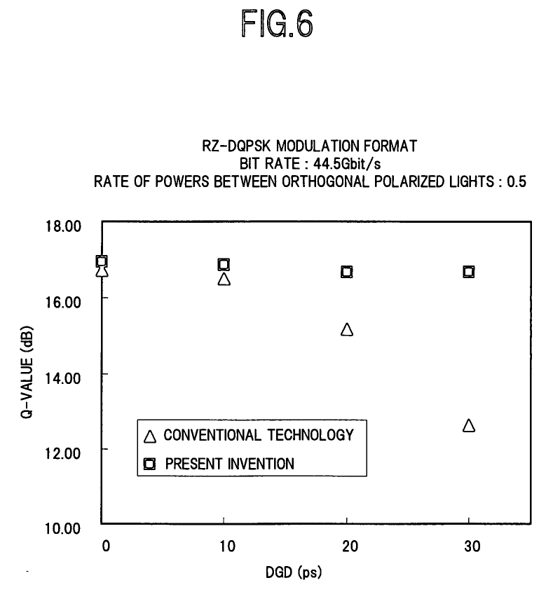

As described above, according to the optical transmission system to which the PMD compensator 10 of the present invention is applied, since the first-order polarization mode dispersion of the RZ-pulsed modulation format signal light is reliably compensated by the PMD compensator 10, it is possible to realize excellent DGD tolerance in the receiver. FIG. 6 shows one example in which the DGD tolerance in the receiver in the present invention is compared with that in the conventional technology for when the rate of the powers between the orthogonal polarized lights of the signal light input to the PMD compensator is 0.5. Herein, the RZ-DQPSK signal light of 44.5 Gbit/sec is supposed. From FIG. 6, it is understood that the DGD tolerance in the receiver is significantly improved by applying the PMD compensator of the present invention.

Next, there will be described a second embodiment of the present invention.

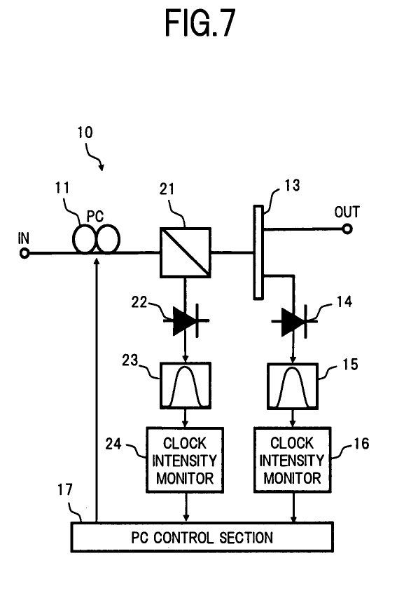

FIG. 7 is a diagram showing a configuration of a PMD compensator according to the second embodiment of the present invention.

In FIG. 7, the PMD compensator 10 of the present embodiment is configured such that, for the configuration of the first embodiment shown in FIG. 1, a polarization beam splitter 21 is disposed in place of the polarizer 12, and an input port of the optical coupler 13 is connected to one of output ports of the polarization beam splitter 21 while a photodiode 22, a band-pass filter 23 and a clock intensity monitor 24 being connected in sequence to the other output port of the polarization beam splitter 21.

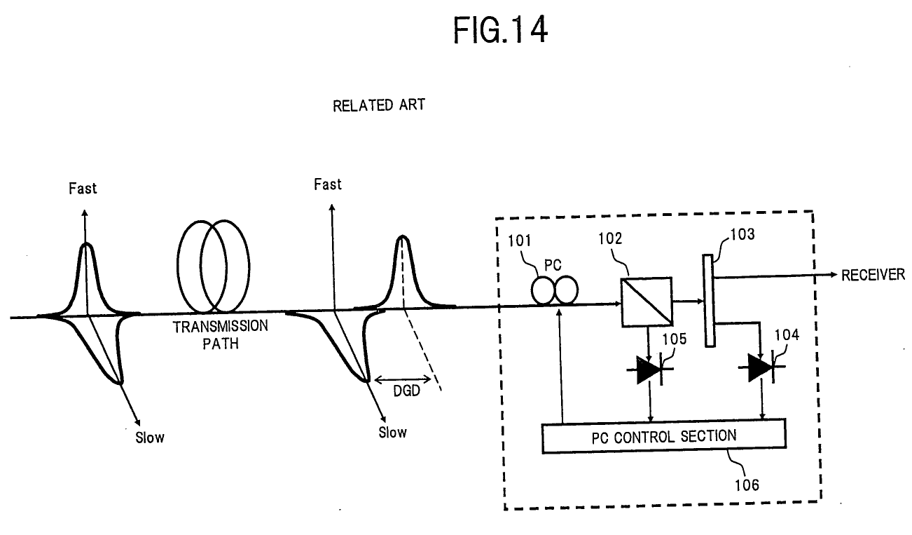

Similarly to a conventional configuration shown in FIG. 14, the polarization beam splitter 21 is for splitting quadrature polarization components from the signal light output from the polarization controller 11. One of the polarization components split by the polarization beam splitter 21 is input to the optical coupler 13 to be branched into two in the same way as that in the first embodiment, and the other polarization component is input to the photodiode 22 as a monitor light.

The photodiode 22, the band-pass filter 23 and the clock intensity monitor 24 are those similar to the photodiode 14, the band-pass filter 15 and the clock intensity monitor 16 described in the above. After the monitor light split by the polarization beam splitter 21 is converted into a electrical signal by the photodiode 22, the electrical signal is supplied to the band-pass filter 23 so that a clock is extracted from the electrical signal, and the intensity thereof is monitored by the clock intensity monitor 24 and a monitor result of the clock intensity monitor 24 is transmitted to the PC control section 17.

To the PC control section 17, the monitor results of the clock intensity corresponding to the two orthogonal polarized lights split by the polarization beam splitter 21 are transmitted from the respective clock intensity monitors 16 and 24. At this time, in the case where the polarization controller 11 is controlled at the optimum point, since the crosstalk component due to DGD is eliminated by the polarization beam splitter 21, the monitor light input to each of the photodiodes 14 and 22 has a clear clock waveform corresponding to the RZ pulse of the signal light, so that both of the clock intensity monitored by the clock intensity monitors 16 and 24 become maximum. On the other hand, in the case where the polarization controller 11 is controlled in the deviated state from the optimum point, since the two orthogonal polarization signal light components of different delay amounts interfere with each other due to DGD in the transmission path, the monitor light input to each of the photodiodes 14 and 22 has a distorted clock waveform, so that both of the clock intensity monitored by the clock intensity monitors 16 and 24 are lowered.

Therefore, in the present PMD compensator 10, the polarization controller 11 is feedback controlled by the PC control section 17, so that the sum of the clock intensity monitored by each of the clock intensity monitors 16 and 24 becomes maximum, and also, a difference between each clock intensity becomes minimum. As a result, the polarization controller 11 can be controlled at the optimum point with higher precision.

As described in the above, according to the second embodiment, it becomes possible to realize the miniaturized and low-cost PMD compensator 10 which can further reliably compensate for the first-order polarization mode dispersion of the RZ-pulsed modulation format signal light.

Next, there will be described a third embodiment of the present invention.

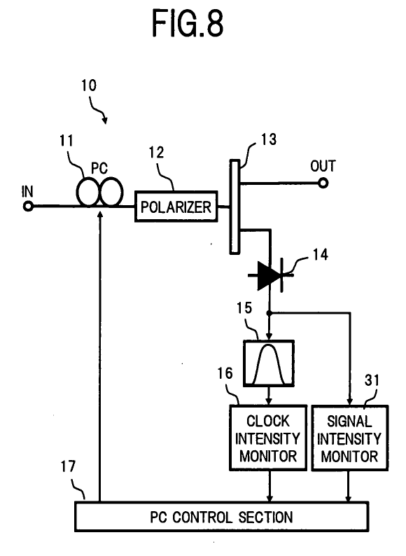

FIG. 8 is a diagram showing a configuration of a PMD compensator according to the third embodiment of the present invention.

In FIG. 8, the PMD compensator 10 of the present embodiment is configured such that, for the configuration of the first embodiment, a signal intensity monitor 31 which monitors the intensity of the electrical signal output from the photodiode 14 is additionally disposed, so that the polarization controller 11 is feedback controlled using not only the clock intensity but also the intensity of the electrical signal, that is, the power of the signal light output via the output terminal OUT.

In the PMD compensator 10 of the above configuration, the polarization controller 11 is feedback controlled by the PC control section 17, so that the clock intensity monitored by the clock intensity monitor 16 becomes maximum, and also, the intensity of the electrical signal (the power of the output signal light) monitored by the signal intensity monitor 31 becomes maximum. As a result, the polarization controller 11 is controlled at the optimum point with higher precision.

As described in the above, according to the third embodiment, it becomes possible to realize the miniaturized and low-cost PMD compensator 10 which can further reliably compensate for the first-order polarization mode dispersion of the RZ-pulsed modulation format signal light.

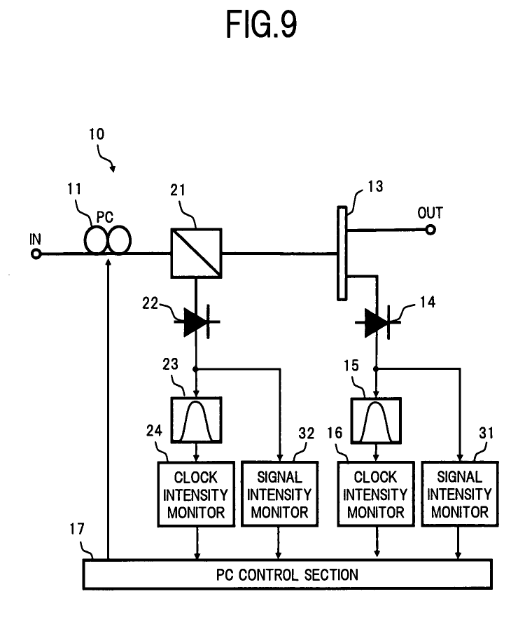

Incidentally, in the third embodiment, there has been shown one example in which, for the configuration of the first embodiment, the signal intensity monitor 31 is additionally disposed. However, as shown in FIG. 9 for example, in the configuration of the second embodiment, there may be disposed signal intensity monitors 31 and 32 which respectively monitor the electrical signals output from the respective photodiodes 14 and 22. In this case, it becomes possible to control the polarization controller 11 at the optimum point with still further higher precision.

Next, there will be described a fourth embodiment.

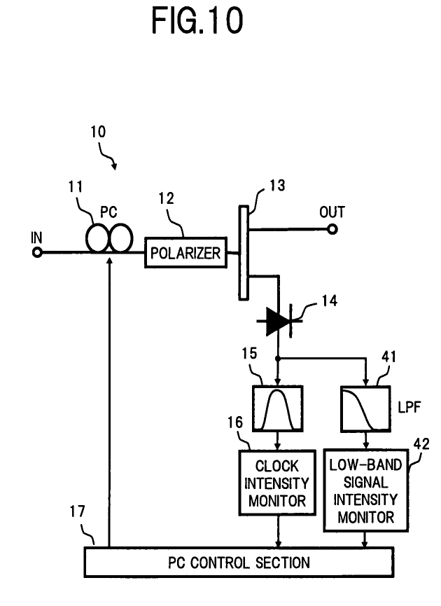

FIG. 10 is a diagram showing a configuration of a PMD compensator according to the fourth embodiment of the present invention.

In FIG. 10, the PMD compensator 10 of the present embodiment is configured such that, for the configuration of the first embodiment shown in FIG. 1 for example, there are disposed a low-pass filter (LPF) 41 to which the electrical signal output from the photodiode 14 is input and a low-band signal intensity monitor 42 to which the transmitted light from the low-pass filter (LPF) 41 is input.

In the configurations of the first to third embodiments, if DGD occurred in the transmission path becomes a multiple of time slot of the signal light, since the change in the clock intensity monitored by the clock intensity monitor 16 is small even though the polarization controller 11 is controlled in the deviated state from the optimum point, there is a possibility of an error in the feedback control of the polarization controller 11. In the case where the signal light input to the input terminal IN is a RZ-pulsed phase modulation format signal light, such an error can be resolved in the fourth embodiment.

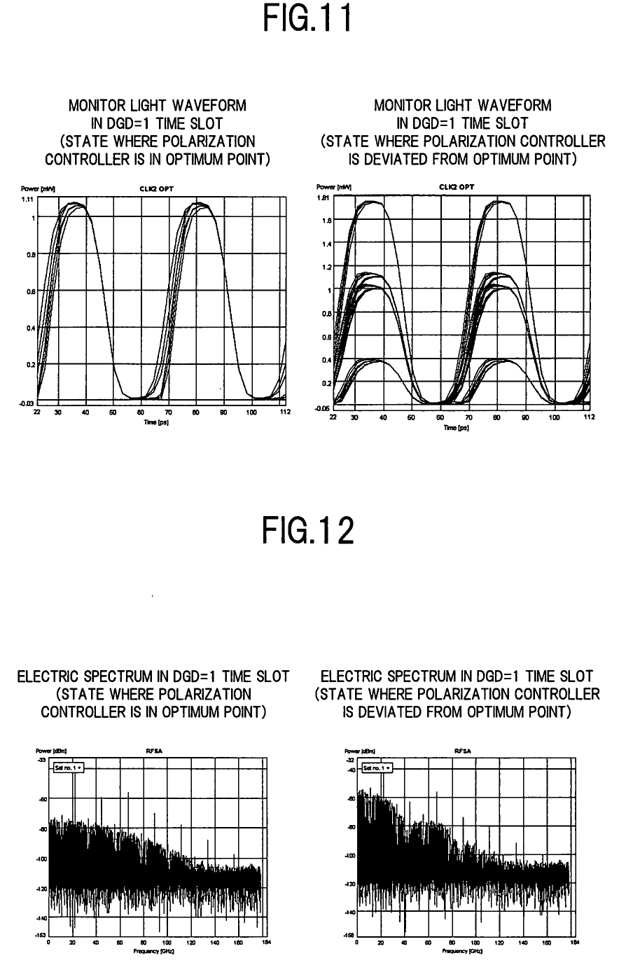

To be specific, in the phase modulation format signal light, in the case where the polarization controller 11 is controlled in the deviated state from the optimum point, the interference occurs between one polarized signal light and another orthogonal polarized signal transmitted earlier (or later) by the multiple of time slot due to PMD. Therefore, for the waveform of the monitor light input to the photodiode 14, as shown in the right side of FIG. 11 for example, although the intensity thereof is varied, the distortion of the RZ-pulsed waveform itself is small. On the other hand, in the case where the polarization controller 11 is controlled at the optimum point, no interference is caused. Therefore, for the waveform of the monitor light input to the photodiode 14, the intensity thereof is not varied as shown in the left side of FIG. 11.

If the RZ-pulsed waveform intensity of the monitor light input to the photodiode 14 is varied due to the interference as described above, as shown in FIG. 12 for example, an electric spectrum (the right side of FIG. 12) of the electrical signal output from the photodiode 14 has a characteristic in which the intensity of low frequency component is increased, compared with the electric spectrum thereof (the left side of FIG. 12) for when the polarization controller 11 is controlled at the optimum point.

Therefore, in the PMD compensator 10 of the present embodiment, a part of the electrical signal output from the photodiode 14 to the band-pass filter 15 is supplied to the low-pass filter 41, the low frequency component of the electrical signal is extracted by the low-pass filter 41, the intensity of the low frequency component is monitored by the low-band signal intensity monitor 42, and a monitor result thereof is transmitted to the PC control section 17. Then, the polarization controller 11 is feedback controlled by the PC control section 17, so that the clock intensity monitored by the clock intensity monitor 15 becomes maximum, and also, the intensity of the low frequency component of the electrical signal monitored by the low-band signal intensity monitor 42 becomes minimum. As a result, the polarization controller 11 is reliably controlled at the optimum point, even if DGD in the transmission path becomes the multiple of time slot of the signal light.

As described above, according to the fourth embodiment, it becomes possible to realize the miniaturized and low-cost PMD compensator 10 which can compensate for the first-order polarization mode dispersion of the RZ-pulsed phase modulation format signal light with high precision.

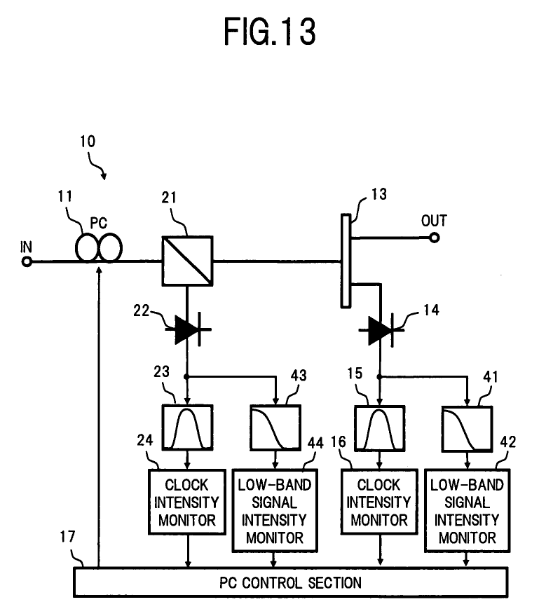

Incidentally, in the fourth embodiment, there has been shown one example in which, for the configuration of the first embodiment, the low-pass filter 41 and the low-band signal intensity monitor 42 are disposed. However, as shown in FIG. 13 for example, for the configuration of the second embodiment, there may be disposed low-pass filters 41 and 43, and low-band signal intensity monitors 42 and 44, which respectively extract the low frequency components of the electrical signals output from the respective photodiodes 14 and 22 to monitor the intensity of the extracted low frequency components. In this case, it becomes possible to compensate for the first-order polarization mode dispersion of the RZ-pulsed phase modulation format signal light with still further higher precision.

What is claimed is:

1. A compensating method of first-order polarization mode dispersion for supplying a RZ-pulsed signal light to a polarization controller and a polarizer in sequence, to compensate for the first-order polarization mode dispersion of said signal light, comprising:
photo-electrically converting a polarized light transmitted through said polarizer to generate a electrical signal;
extracting, from said generated electrical signal, a clock having a frequency corresponding to a RZ clock frequency of said signal light;
monitoring the intensity of said extracted clock; and
controlling said polarization controller so that said monitored intensity of the clock becomes maximum.

2. A compensating method of first-order polarization mode dispersion according to claim 1, wherein said method comprises:
using a polarization beam splitter in place of said polarizer;
photo-electrically converting two orthogonal polarized lights output from said polarization beam splitter to generate electrical signals;
extracting, from said electrical signals, clocks each having a frequency corresponding to the RZ clock frequency of said signal light;
monitoring the intensity of each of said extracted clocks; and
controlling said polarization controller so that the intensity of each of said monitored clocks becomes maximum.

3. A compensating method of first-order polarization mode dispersion according to claim 1,
wherein said method comprises:
monitoring the intensity of said generated electrical signal; and
controlling said polarization controller so that both of the intensity of said monitored clock and the intensity of said electrical signal become maximum.

4. A compensating method of first-order polarization mode dispersion according to claim 1,
wherein when said signal light is a RZ-pulsed phase modulation format signal light,
said method comprises:
extracting, from said electrical signal, a low frequency component;
monitoring the intensity of said extracted low frequency component; and
controlling said polarization controller so that the intensity of said monitored clock becomes maximum, and also, the intensity of said monitored low frequency component becomes minimum.

5. A first-order polarization mode dispersion compensator for supplying a RZ-pulsed signal light input to an input terminal thereof to a polarization controller and a polarizer in sequence, to output a signal light of which first-order polarization mode dispersion is compensated, via an output terminal thereof, comprising:
an optical coupler which branches a part of a polarized light transmitted through said polarizer to be sent to said output terminal as a monitor light;
a first photodiode which photo-electrically converts the monitor light branched by said optical coupler to generate a electrical signal;
a first band-pass filter which extracts, from the electrical signal generated by said first photodiode, a first clock having a frequency corresponding to a RZ clock frequency of said signal light;
a first clock intensity monitor which monitors the intensity of the first clock extracted by said first band-pass filter; and
a control section that controls said polarization controller so that the intensity of the first clock monitored by said first clock intensity monitor becomes maximum.

6. A first-order polarization mode dispersion compensator according to claim 5,
wherein said compensator is disposed with a polarization beam splitter in place of said polarizer, to supply to said optical coupler one of two orthogonal polarized lights output from said polarization beam splitter, and also, further comprises:
a second photodiode which photo-electrically converts the other polarized light output from said polarization beam splitter to generate a electrical signal;
a second band-pass filter which extracts, from the electrical signal generated by said second photodiode, a second clock having a frequency corresponding to the RZ clock frequency of said signal light; and
a second clock intensity which monitors the intensity of the second clock extracted by said second band-pass filter, and
said control section controls said polarization controller so that both of the intensity of the first clock monitored by said first clock intensity monitor and the intensity of the second clock monitored by said second clock intensity monitor become maximum.

7. A first-order polarization mode dispersion compensator according to claim 5,
wherein said compensator further comprises;
a first signal intensity monitor which monitors the intensity of the electrical signal generated by said first photodiode, and
said control section controls said polarization controller so that both of the intensity of the first clock monitored by said first clock intensity monitor and the intensity of the electrical signal monitored by said first signal intensity monitor become maximum.

8. A first-order polarization mode compensator according to claim 6,
wherein said compensator further comprises:
a first signal intensity monitor which monitors the intensity of the electrical signal generated by said first photodiode; and
a second signal intensity monitor which monitors the intensity of the electrical signal generated by said second photodiode, and
said control section controls said polarization controller so that both of the intensity of the first clock monitored by said first clock intensity monitor and the intensity of the electrical signal monitored by said first signal intensity monitor become maximum, and also, both of the intensity of the second clock monitored by said second clock intensity monitor and the intensity of the electrical signal monitored by said second signal intensity monitor become maximum.

9. A first-order polarization mode compensator according to claim 5,
wherein when said signal light is a RZ-pulsed phase modulation format signal light,
said compensator comprises:
a first low-pass filter which extracts a low frequency component from the electrical signal generated by said first photodiode; and
a first low-band signal intensity monitor which monitors the intensity of the low frequency component extracted by said first low-pass filter, and
said control section controls said polarization controller so that the intensity of the first clock monitored by said first clock intensity monitor becomes maximum, and also, the intensity of the low frequency component monitored by said first low-band signal intensity monitor becomes minimum.

10. A first-order polarization mode dispersion compensator according to claim 6,
wherein when said signal light is a RZ-pulsed phase modulation format signal light,
said compensator comprises:
a first low-pass filter which extracts a low frequency component from the electrical signal generated by said first photodiode;
a first low-band signal intensity monitor which monitors the intensity of the low frequency component extracted by said first low-pass filter;
a second low-pass filter which extracts a low frequency component from the electrical signal generated by said second photodiode; and
a second low-band signal intensity monitor which monitors the intensity of the low frequency component extracted by said second low-pass filter, and
said control section controls said polarization controller so that the intensity of the first clock monitored by said first clock intensity monitor becomes maximum and also the intensity of the low frequency component monitored by said first low-band signal intensity monitor becomes minimum, and at the same time, the intensity of the second clock monitored by said second clock intensity monitor becomes maximum and also the intensity of the low frequency component monitored by said second low-band signal intensity monitor becomes minimum.

11. An optical transmission system comprising a first-order polarization mode dispersion compensator recited in claim 5.

12. An optical transmission system according to claim 11, further comprising;
a chromatic dispersion compensator which compensates for chromatic dispersion of the signal light input to said first-order polarization mode dispersion compensator.

13. An optical transmission system according to claim 11, further comprising;
an optical amplifier which performs an automatic level control on the power of the signal light output from said first-order polarization mode dispersion compensator.
